(19) United States
(12) Patent Application Publication
(10) Pub. No.: US 2014/0176293 A1
(43) Pub. Date: Jun. 26, 2014

(54) MECHANICAL FLEXIBLE THERMAL TRIP UNIT FOR MINIATURE CIRCUIT BREAKERS

(71) Applicant: SCHNEIDER ELECTRIC USA, INC., Palatine, IL (US)

(72) Inventors: Juan Ignacio Melecio, Celaya (MX); Mauricio Diaz, San Nicolas de los Garza (MX); Luis Islas, San Pedro Garza Garcia (MX)

(21) Appl. No.: 13/724,016

(22) Filed: Dec. 21, 2012

(51) Int. Cl. H01H 77/04

(52) U.S. Cl. CPC H01H 77/04
USPC 337/12

(57) ABSTRACT

A flexible thermal trip actuator unit for a circuit breaker is disclosed. The circuit breaker prevents electrical connection between a power line source in the event of an over current. The circuit breaker includes a line connector, a load connector and a trip mechanism. The trip mechanism has an on position allowing electrical connection between the line connector and the load connector, a tripped position interrupting electrical connection between the line connector and the load connector in response to detection of a high current condition, and an off position which is required before resetting the trip mechanism to the on position. The actuator unit has a cold bar coupled to the trip mechanism, a compliant hinge and a parallel hot bar electrically coupled to the load connector. The cold bar deforms from a high current to cause the trip mechanism to assume the tripped position.

### TECHNICAL FIELD

Aspects disclosed herein relate generally to circuit breakers, and, more particularly, to a flexible actuator trip unit for a circuit breaker.

### BACKGROUND

As is well-known, circuit breakers provide automatic power interruption to a monitored load when undesired fault conditions, such as an overload of current or a short circuit, occur. A circuit breaker is typically wired between a load source and a power source on a line conductor. The load receives power from the line conductor from the circuit breaker and is directly connected to a ground conductor. A neutral rail or conductor is also connected to the power source through the circuit breaker to provide a return for the current back to the power source. A circuit breaker is an automatically operated electro-mechanical device designed to protect the load from damage when a fault occurs by breaking the connection on the line conductor to the load. A typical circuit breaker has a load connector and a line connector with a break mechanism interposed between the load connector (connected to the power input of a load device) and the line connector (connected to the power lead of a power source such as a panel board). Various fault conditions trip the circuit breaker thereby interrupting power flow between the load and the power source. A circuit breaker can be reset (either manually or automatically) to resume current flow to the load.

Thermal-magnetic circuit breakers have mechanical mechanisms that are tripped by overcurrents to interrupt power to a load. Typically, a trip mechanism is employed that includes a spring-biased trip lever. The trip lever is seated in the slot of an armature and held in place by a latch. The armature includes a bimetal strip having an actuator that is in contact with the latch. The opposite end of the bimetal strip is coupled to a terminal bar that is a conductor to the load connector of the circuit breaker. An overcurrent may be detected when the fault current generates sufficient heat in a bimetal strip causing the strip to bend and therefore move the armature. The mechanical deflection causes the spring to move the lever to force a moveable contact attached to a moveable conductive blade away from a stationary contact, thereby breaking the circuit.

Currently bimetal strips in the trip mechanism are not energy efficient and require relatively greater amounts of material, which requires relatively larger casings for the circuit breaker. Further, a bimetal strip requires at least a thermal conductor to provide the current flow from the load connector. This necessity for at least two parts increases complexity of assembly, frictional failure due to the contact of two parts, and costs.

### BRIEF SUMMARY

The disclosed examples relate to a trip unit in a circuit breaker having an embedded monolithic mechanical flexible thermal actuator. The monolithic mechanical flexible actuator is capable of sensing when undesired over current conditions occur, such as overloads and short circuits. The flexible element then actuates the circuit breaker trip mechanism. The low cost design is made in a single piece and includes the thermal trip unit and the terminal in a single compliant piece that may replace existing bimetal and terminal conductor parts. Magnetic actuation is also performed by the mechanical flexible thermal actuator connected with the magnetic yoke and armature. The thermal unit provides equivalent motion to the bimetal in known circuit breakers, but presents the advantage of having a monolithic construction that is highly energy efficient. The energy efficiency of the disclosed thermal unit allows the use of smaller circuit breakers, reduced number of parts, and associated manufacturing costs. Further, the size and cost of load centers and panel boards where such smaller circuit breakers are mounted can also be reduced significantly because they have to manage less heat generation.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1A is a perspective view of the front of a known circuit breaker;

FIG. 1B is a perspective view of the back of the circuit breaker in FIG. 1A;

FIG. 2A is a cross-section view of the internal components of the circuit breaker in FIG. 1A with the handle in the on position;

FIG. 2B is a cross-section partial view of the internal components of the circuit breaker in FIG. 1A with the handle in the tripped position;

FIG. 2C is a cross-section partial view of the internal components of the circuit breaker in FIG. 1A with the handle in the off position for a reset;

FIG. 3A is a close up perspective view of the internal components of the circuit breaker in FIG. 1A showing an actuator with a compliant thermal bar for greater energy efficiency;

FIG. 3B is a close up cross-section view of the internal components of the circuit breaker in FIG. 1A showing the actuator with the compliant thermal bar;

FIG. 4 is a perspective close-up view of the actuator in FIG. 3A and 3B;

FIG. 5A is a graphic of the actuator in FIG. 3A and 3B showing the current path through the actuator;

FIG. 5B is a graphic of the actuator in FIG. 3A and 3B showing the compliant surfaces interfacing with the casing of the circuit breaker; and

FIG. 5C is a graphic of the actuator in FIG. 3A and 3B showing deformation of the bars when an over current flows through the actuator.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

One disclosed example is a circuit breaker preventing electrical connection between a power line source in the event of an over current. The circuit breaker includes a line connector and a load connector. The circuit breaker also includes a trip mechanism having an on position allowing electrical connection between the line connector and the load connector and a tripped position interrupting electrical connection between the line connector and the load connector in response to detection of a high current condition. The circuit breaker includes an actuator having a compliant hinge, a cold bar coupled to the trip mechanism, and a parallel hot bar electrically coupled to the load connector. The cold bar deforms from the high current condition to cause the trip mechanism to assume the tripped position.

Another disclosed example is a one piece mechanical actuator for use in conjunction with a trip mechanism of a circuit breaker. The actuator includes a cold bar and a hot bar parallel to the cold bar. The actuator also includes a compliant flexible hinge coupling the cold bar with the hot bar. A high current condition causes the deformation of the cold bar relative to the flexible hinge.

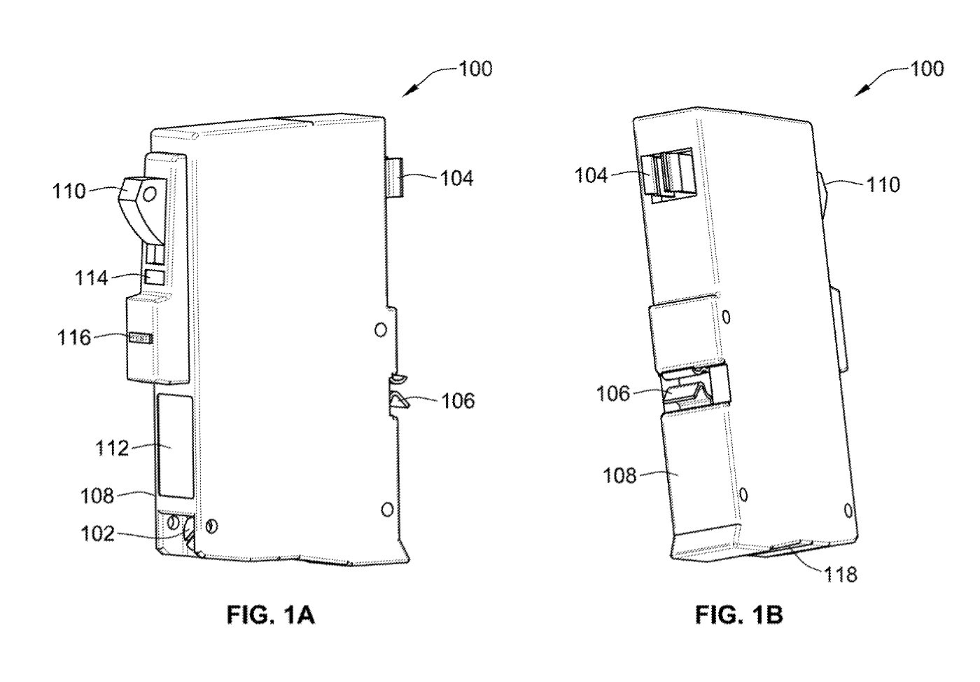

Turning now to FIGS. 1A and 1B, a perspective view of the front and back of a circuit breaker 100 is shown. The circuit breaker 100 includes a load side connector 102, a power line connector 104, a plug-on panel neutral line connector 106, and a casing 108. The load side connector 102 is affixed to one side of the casing 108 and the power line connector 104 is affixed to the opposite side of the casing 108. A handle 110 connected to a trip mechanism (detailed below) is mounted on a front panel 112. The handle 110 may be placed in an on position (up position shown in FIG. 1A) that causes the circuit breaker 100 to allow current flow between the power line connector 104 and the load side connector 102. The handle 110 may be placed in a tripped condition cutting off current flow between the power line connector 104 and the load side connector 102. A lens 114 is mounted below the handle 110 and shows an indication that the handle 110 is in a trip condition. A test button 116 is provided to test the internal electronics of the circuit breaker 100. In this example, the circuit breaker 100 may be a miniature circuit breaker, such as the QO® and HOMELINE® family of circuit breakers available from Square D by Schneider Electric. However, it is to be understood that the principles discussed herein may be applied to other types of circuit breakers or other thermal overload protection devices. For example, thermal trip systems are used in motor protection devices and the principle of operation will be the same for such devices. A power line source (not shown) such as a panel board is coupled to the circuit breaker 100 via connecting the line side connector 104 to the power line and a neutral line side rail to the plug-on panel neutral line connector 106. A load may be connected to the circuit breaker by connecting the load side connector 102 to the power line to the load and a load neutral connector 118 to a neutral terminal on the load.

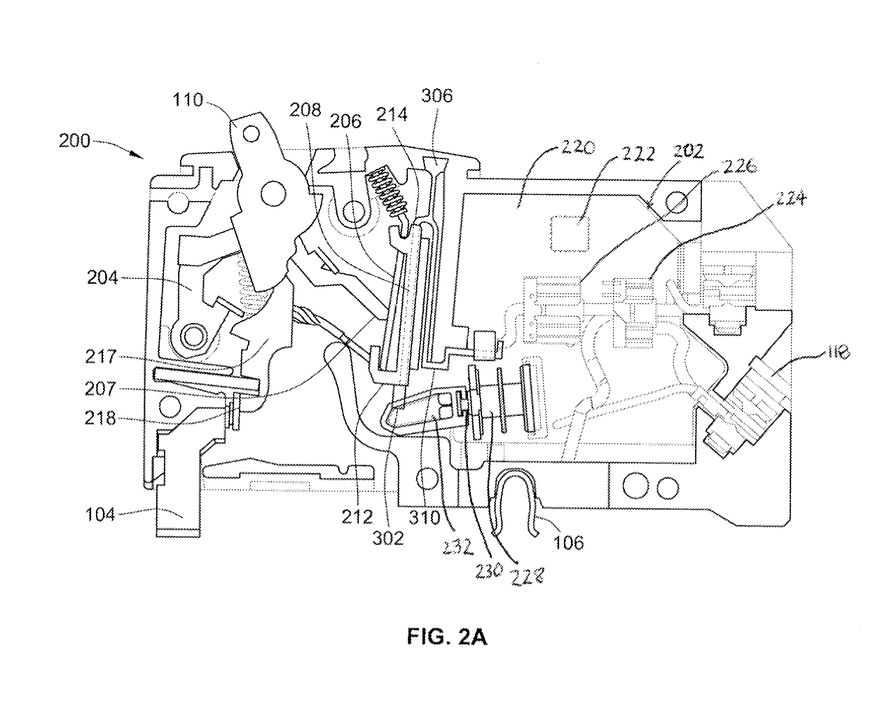

FIGS. 2A-2C are cross-section views of the internal components of the circuit breaker 100 in FIGS. 1A-1B with the cover of the casing 108 removed. Like elements from FIG. 1A-1B have like element numbers in FIGS. 2A-2C. The circuit breaker 100 contains a trip mechanism 200 and an electronics module 202. The trip mechanism 200 includes a trip lever 204 connected to the handle 110. The trip lever 204 is roughly U-shaped having one end 205 that is in pivoting connection with the casing 108. A latch 207 of the trip lever 204 is engaged with a slot in a latch seat 206 of an armature 208. The armature 208 is in a calibrated position such that a free end 210 of the armature 208 contacts a yoke hook 212. The armature 208 is biased in the calibrated position via a spring 211. The yoke hook 212 may be triggered by an actuator 214 that bends when a heat threshold is exceeded by current flowing through a cold arm, thus causing the armature 208 to be released from the yoke hook 212 and releases the latch 207 from the latch seat 206. A rotating contact arm 217 is rotatably coupled to the handle 110. A spring 216 is coupled between the rotating contact arm 217 and the trip lever 204, and drives the trip lever 204 and the handle 110 to the trip position (shown in FIG. 1A and 2B). The movement of the trip lever 204 to the trip position breaks the electrical path between the power line connector 104 and the load power connector 102 by moving a contact 218 of the contact arm 217 away from the power line connector 104. The trip mechanism 200 thus has an on position allowing electrical connection between the line connector 104 and the load connector 102. The trip mechanism 200 has a tripped position interrupting electrical connection between the line connector 104 and the load connector 102 in response to detection of a high current condition. The trip mechanism 200 has an off position, which is required before resetting the trip mechanism 200 to the on position.

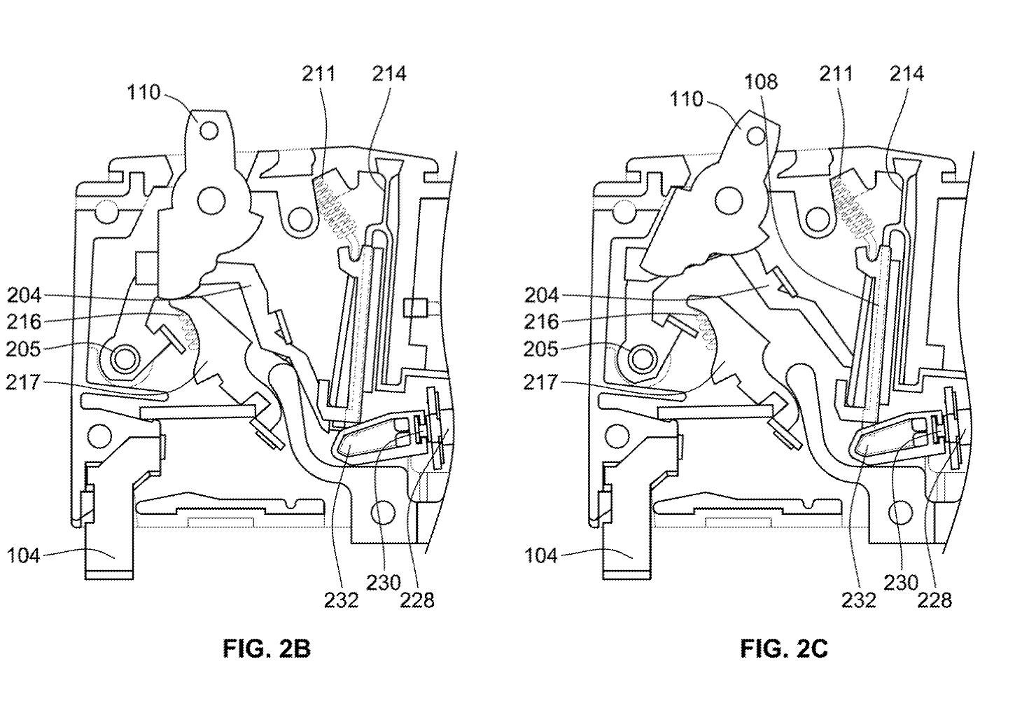

As will be explained below in reference to FIGS. 3A-3B, the actuator 214 includes a cold bar 302, which is coupled to the trip mechanism 200. The cold bar 302 is coupled to a compliant hinge 304, which is attached to a block shaped mounting support 306, which mounts the actuator 214 in the casing of the circuit breaker 100. A parallel hot bar 308 has one end that extends from the hinge 304. An opposite end of the hot bar 308 from the hinge 304 is connected to a perpendicular support 310. A terminal arm 312 extends from the support 310 and serves as an electrical contact for current flow through the actuator 214. The end of the terminal arm 312 extends at a perpendicular angle from the hot bar 308 and includes a hook 314, which may be electrically coupled to the load side connector 102. The hook 314 may be welded to a wire or otherwise connected to the load side connector 192 to electrically connect the hot bar 308.

As shown in FIG. 2B, the handle 110 is in the tripped position. The trip lever 204 has rotated to a down position by force applied by the spring 216 because the latch 207 has been tripped by the deformation of the actuator 214 and has been moved out of the latch seat 206. The rotating contact arm 217 has also been moved by the spring 216 to a downward position separating the contact 218 from the power line connector 104. As shown in FIG. 2B, the handle 110 is in contact with a pin 219, which protrudes from the trip lever 204.

In order to reset the handle 110 to the on position, the handle 110 is moved to the off position as shown in FIG. 2C. The movement of the handle 110 tensions the spring 216 by rotating the trip lever 204 via pushing against the protruding pin 219. The trip lever 204 is thus rotated so the latch 207 rests in the latch seat 206 of the armature 208.

The handle 110 is then moved to the on position as shown in FIG. 2A. In doing so, the contact arm 217 is rotated to bring the contact 218 to create an electrical contact with the power line connector 104. In doing so, the contact arm 217 stretches the spring 216. The trip lever 204 remains in the upward position because the latch 207 remains engaged in the latch seat 206 of the armature 208.

The electronics module 202 includes a circuit board 220 that mounts a microprocessor 222, a ground fault sensor 224, a current sensor 226, and a trip solenoid 228. It is to be understood that the functions of the microprocessor 222 may be performed by a processor, microcontroller, controller, and/or one or more other suitable processing device(s) such as an application specific integrated circuit (ASIC), a programmable logic device (PLD), a field programmable logic device (FPLD), a field programmable gate array (FPGA), discrete logic, etc.

The microprocessor 222 may electronically cause the circuit breaker 100 to trip based on signals sensed by the ground fault sensor 224 or the current sensor 226 from the current flowing between the load connector 102 and the line connector 104. The electronics module 202 therefore adds additional functionality for tripping the circuit breaker 100 other than high current conditions that detected through the actuator 214 as will be explained below. The electronics module 202 controls tripping the circuit breaker 100 based on conditions detected by the sensors 224 and 226. On detection of a fault condition, the microprocessor 222 sends a signal to a trip circuit that causes the trip solenoid 228 to activate a plunger 230 to pull a connected trip link 232 down. The trip link 232 includes a clamp 234 that is in contact with the armature 208. When the trip link 232 is motivated by the plunger 230 being activated by the solenoid 228, it moves downward pushing the clamp 234 thus causing the armature 208 to move downward to release the latch 207 causing the spring 216 to drive the trip lever 204 and handle 110 to the trip position thus breaking the electrical path between the line connector 104 and the load connector 102. The microprocessor 222 analyzes the signals from the sensors 224 and 226 for indicators of fault conditions that may include, but are not limited to ground faults, arcing faults, overloads, and short-circuits. When the microprocessor 222 determines a safe condition, it deactivates the solenoid 228 releasing the plunger 230 and pushing the trip link 232 and the clamp 234 upwards. This allows the armature 208 to be tensioned in the set position to hold the latch 207 of the trip lever 204 as shown in FIG. 2A

The microprocessor 222 monitors the inputs from several input circuits mounted on the circuit board 220 including a zero crossing circuit and voltage monitoring circuit, a differential current sensor circuit, an integrator circuit, a high frequency detection circuit, a push to test circuit, and a temperature sensor circuit. In this example, the differential current sensor circuit is coupled to the ground fault sensor 224. The ground fault sensor 224 and differential current sensor circuit provide an input to the microprocessor 222 indicating the presence of a ground fault or arcing ground fault from the load connector 102. The current sensor 226 and the integrator circuit provide an input to the microprocessor 222 indicating the presence of an arc fault on the load connector 102.

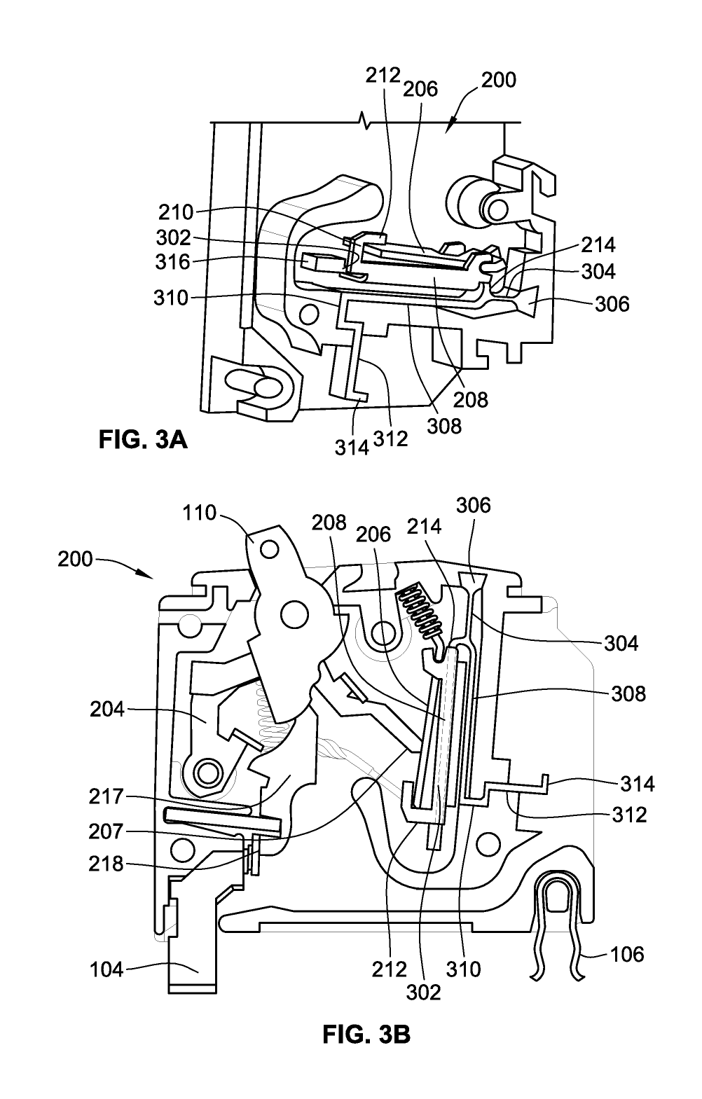

FIG. 3A is a perspective view and FIG. 3B is a cross section view of the actuator 214 in FIG. 2A. FIG. 4 is an isolated perspective view of the actuator 214. Like element numbers in FIGS. 1 and 2 are designated with the same element numbers in FIGS. 3A-3B and 4. The actuator 214 is an integrated unit that includes a cold bar 302, which is engaged with the armature 208 in FIG. 2A. As may be seen in FIGS. 3A-3B, the cold bar 302 is connected to the hinge 304, which is also connected to parallel hot bar 308. The hinge 304 is connected to the mounting support 306, which fixes the actuator 214 against the casing of the circuit breaker 100. As is understood, the cold bar 302 is a thermal actuator that generates movement through the heating of segments through a current overload that trips the trip mechanism 200 shown in FIG. 2A. Current bi-material thermal actuators employ the difference in thermal expansion between two materials. In this example, the actuator 214 is a single material thermally driven beam flexure actuator or heat drive actuator. The actuator 214 is preferably fabricated from Aluminum 6101 and therefore eliminates the need for two different materials as in current bi-material actuators. Other materials such as copper may be used form actuator 214. The hinge 304 constitutes a compliant flexure allowing relative rotation of the upper cold bar 302 relative to the lower hot bar 308. As shown in FIG. 3A-3B and 4, the actuator 214 has a simple compliant design based on the hinge 304, which amplifies the motion from the thermal expansion of a single material such as that of the cold bar 302. The hinge 304 includes a support member 318 that is connected to the cold bar 302 and the hot bar 308. A flexure member 320 has one end perpendicularly attached to the support member 318 and an opposite end attached to the mounting support 306.

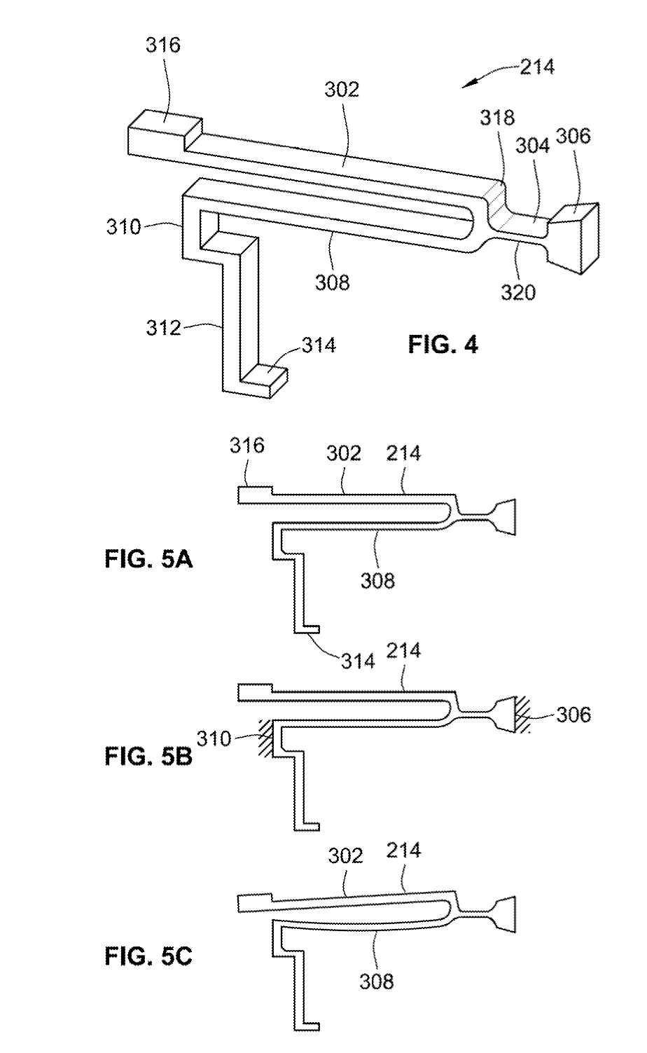

When an overcurrent is passed through the circuit breaker 100, the hot bar 308, which has a higher resistance because it is thinner than the cold bar 302, heats up more than the cold bar 302. The heat results in a larger thermal expansion for the hot bar 308 which results in horizontal displacement of the hot bar 308 into the hinge 304. The horizontal displacement of the hot bar 308 translates into a larger vertical displacement of the cold bar 302 due to the leverage configuration of the actuator 214 with the hinge 304. This results in a conductive joint 316 at the end of the cold bar 302 of the actuator 214 being deflected laterally by the cold bar 302 deforming. The shape of the actuator 214 and specifically the hinge 304 amplifies the thermal expansion effect of the hot bar 308 thereby resulting in less material requirements than known bimetal strips. FIG. 5A shows the current path through the actuator 214. As shown in FIG. 5A, the current flows from the conductive joint 316 of the cold bar 302 through the hot bar 308 and into the hook 314. FIG. 5B shows the geometric constraints on the actuator 214 in the form of walls of the casing of the circuit breaker 100 that allow insertion of the actuator 214. As may be seen in FIG. 5B, the geometric constraints (shown in cross-hatching) include contact with the mounting support 306 attached to the hinge 304 and the support 310 attached to the terminal arm 312 to fit the actuator 214 within the casing of the circuit breaker 100. The contact surfaces on the mounting support 306 and the support 310 allow the actuator 214 to be fit within the casing while providing flexibility of movement of the cold bar 302.

FIG. 5C is a graphic that shows the deformation of the actuator 214 in a high current condition. The cold bar 302 between the conductive joint 316 and the connection to the hinge 304 experiences the deformation in the high current condition as shown in FIG. 5C. As may be seen in FIG. 5C, the conductive joint 316 is deflected laterally in the high current condition. The deformation of the cold bar 302 results in releasing the latch 207 of the trip mechanism 200 thereby interrupting electrical contact between the load connector 102 and the line connector 104 in FIG. 2A. As may be shown, the hot bar 308 is deformed less than the cold bar 302.

Since the actuator 214 integrates the terminal arm 312 with the hinge 304 and bars 302 and 308, it replaces known bi-metal arrangements that required at least two parts. The monolithic actuator 214 is a simpler compliant construction because it minimizes moveable parts and joints. The monolithic integrated nature of the actuator 214 results in lower assembly time and cost. The monolithic construction of the actuator 214 also prevents sliding friction between parts.

The dimensions of the actuator 214 may be adjusted for the desired current level to produce the deformation of the cold bar 302. Thus, thicker dimensions may be used for detection of higher currents for the cold bar 302 or both the cold bar 302 and the hot bar 308. Further, the cross section area of the cold bar 302 and the hot bar 308 may be increased to accommodate higher currents before the deformation of the cold bar 302. Further, the location of the flexure member 320 relative to the support member 318 may designed to increase the amplification of deformation. For example, the flexure member may be attached on the support member 318 closer to the attachment of the hot bar 308 to amplify the deflection of the cold bar 302.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A circuit breaker preventing electrical connection between a power line source in the event of an over current, the circuit breaker comprising:
a line connector;
a load connector;
a trip mechanism having an on position allowing electrical connection between the line connector and the load connector and a tripped position interrupting electrical connection between the line connector and the load connector in response to detection of a high current condition; and
an actuator having a compliant hinge, a cold bar coupled to the trip mechanism, and a parallel hot bar electrically coupled to the load connector, the cold bar deforming from the high current condition to cause the trip mechanism to assume the tripped position.

2. The circuit breaker of claim 1, wherein the actuator is fabricated from aluminum.

3. The circuit breaker of claim 1, wherein the actuator has contact surfaces with the casing of the circuit breaker.

4. The circuit breaker of claim 1, wherein the dimensions of the cold bar and the hot bar are selected based on a predetermined high current condition.

5. The circuit breaker of claim 1, wherein the hot bar is thinner than the cold bar, causing the tip of the cold bar to laterally deflect in the high current condition.

6. The circuit breaker of claim 1, wherein the actuator is a single piece.

7. The circuit breaker of claim 1, wherein the hinge has a flexure member having a first end coupled to a mounting support and an opposite end coupled to a support member holding the cold and hot bars.

8. The circuit breaker of claim 1, further comprising an electronic trip module including a sensor for abnormal current conditions and a trip actuator coupled to the trip mechanism, the electronic trip module causing the trip actuator to cause the trip mechanism to assume the tripped position when an abnormal current condition is detected.

9. A one piece mechanical actuator for use in conjunction with a trip mechanism of a circuit breaker, the actuator comprising:
a cold bar;
a hot bar parallel to the cold bar;
a compliant flexible hinge coupling the cold bar with the hot bar, wherein a high current condition causes the deformation of the cold bar relative to the flexible hinge.

10. The actuator of claim 9, further comprising a terminal conductor coupled to the hot bar.

11. The actuator of claim 9, further comprising a mounting support coupled to the hinge, the mounting support including a compliant surface for contact with a casing of the circuit breaker.

12. The actuator of claim 9, wherein the actuator is aluminum.

13. The actuator of claim 9, wherein the dimensions of the cold bar and the hot bar are selected based on a predetermined high current condition.

14. The actuator of claim 9, wherein the hot bar is thinner than the cold bar, causing the tip of the cold bar to laterally deflect in a high current condition.

15. The actuator of claim 9, wherein the hinge has a flexure member having a first end coupled to a support block and an opposite end coupled to a support member holding the cold and hot bars.
